(19) United States
(12) Patent Application Publication
(10) Pub. No.: US 2012/0191626 A1
(43) Pub. Date: Jul. 26, 2012

(54) Methods and Systems for Generating a Forward Implied Variance Index and Associated Financial Products

(76) Inventors: Chan Ahn, (US); Edin Buturovic, (US); Ramanujachary Kumanduri, (US)

(21) Appl. No.: 13/289,915

(22) Filed: Nov. 4, 2011

Related U.S. Application Data
(60) Provisional application No. 61/410,252, filed on Nov. 4, 2010.

(51) Int. Cl. G06Q 40/06

(52) U.S. Cl. 705/36 R

(57) ABSTRACT

The FIVI may generate and manage forward-variance-sensitive financial indices and the associated portfolios of investment vehicles underlying them, as well as for construct tradable financial products based on the values of those indices. The FIVI may generate one or more indices reflective of a one-period (e.g., one-month) forward starting variance, which may provide exposure to implied volatility without significant exposure to realized volatility. The FIVI may replicate forward variance of an index by maintaining a portfolio of call and put options which may further employ delta-hedging. Maintenance of FIVI portfolios may further employ rolling, ongoing and/or periodic rebalancing.

### CROSS REFERENCE TO RELATED APPLICATION

This application claims priority to U.S. Provisional Patent Application Ser. No. 61/410,252, filed Nov. 4, 2010, which is herein incorporated by reference in its entirety.

### FIELD

The present invention is directed generally to methods and systems for creating financial indices and financial instruments. More particularly, the invention is directed to METHODS AND SYSTEMS FOR GENERATING A FORWARD IMPLIED VARIANCE INDEX AND ASSOCIATED FINANCIAL PRODUCTS.

### BACKGROUND

Financial volatility is a measure of the risk associated with a particular investment or instrument, reflecting the stochastic properties of financial valuation. For example, the standard deviation of the performance of a given instrument, collection of instruments, or index is one way to measure or define volatility. Like the value of the underlying assets, the volatility may also vary with time and market conditions. There are two types of volatility, one backward looking, and one forward looking. The backward-looking measure of volatility is called realized volatility and is determined by the historical price fluctuations of a given investment. The forward-looking measure of volatility is called implied volatility which may be determined by evaluating a current price of a given investment together with an appropriate pricing model predicting the price of the investment at some time in the future.

### SUMMARY

The METHODS AND SYSTEMS FOR GENERATING A FORWARD IMPLIED VARIANCE INDEX AND ASSOCIATED FINANCIAL PRODUCTS (hereinafter “FIVI”) provide facilities for generating and managing forward-variance-sensitive financial indices and the associated portfolios of financial instruments underlying these indices, as well as for constructing tradable financial products based on or otherwise influenced by the values of these indices. In one embodiment, the FIVI may generate, and maintain one or more indices reflective of a one-period (one month, for example) starting forward variance, which may provide exposure to implied volatility while limiting exposure to realized volatility. In one exemplary embodiment, approximation of such a forward variance may be achieved by maintaining a portfolio of call and put options which may further employ delta-hedging. In one embodiment, maintenance of FIVI portfolios may further employ periodic rebalancing on a rolling basis.

In one embodiment, a processor-implemented method for approximating the forward implied variance of an index of underlying financial instruments is disclosed. The method includes accessing information from at least one database regarding performance information for an underlying index of financial instruments; establishing, using a controller module, a short position in a one-period variance portfolio at the beginning of a period, the one-period variance portfolio including a plurality of one-period options on the underlying index of financial instruments; establishing, using a controller module, a long position in a two-period variance portfolio at the beginning of the period, the two-period variance portfolio including a plurality of two-period options on the underlying index; establishing, using a controller module, a three-period variance portfolio without taking an initial position in the portfolio at the beginning of the period; and rebalancing among the three portfolios at predetermined intervals during the period, such that at the expiration of the period, the long and short positions with respect to a one-period variance portfolio and a two-period variance portfolio are the same as they were on the initial day of the period.

A system for approximating the forward implied variance of an underlying index of financial instruments is also disclosed. The system includes: a server having a controller running on a processor and configured to interface with a plurality of databases to access information regarding performance information for an underlying index of financial instruments; an index calculator module interfacing with the controller and configured to calculate a first one-period forward implied variance and a first two-period forward implied variance for the underlying index at a first time; to calculate a second one-period forward implied variance and a second two-period forward implied variance for the underlying index at a second time; and to calculate a forward implied variance index value at the second time by multiplying a forward implied variance index value at the first time by a weighted sum of the first one-period forward implied variance, the second one-period forward implied variance, the first two-period forward implied variance, and the second two-period forward implied variance; a market interface module interfacing with the controller and configured to establish a forward implied variance portfolio consisting of a short position in a one-period sub-portfolio, a long position in a two-period sub-portfolio, and no position in a three-period sub-portfolio, the calculated forward implied variance of the underlying index; and a portfolio manager module interfacing with the controller and configured to periodically rebalance the sub-portfolios by purchasing shares in the one-period sub-portfolio, selling shares in the second period sub-portfolio, and purchasing shares in the three-period sub-portfolio, in a quantity such that at expiration of the one period, the two-period portfolio becomes a new one-period portfolio with a short position, and the three-period portfolio becomes a new two-period portfolio with a long position.

In one embodiment, a forward implied variance index instrument generating processor-implemented method is disclosed, comprising: establishing an index portfolio comprising a plurality of variance portfolios, wherein the plurality of variance portfolios comprise pluralities of call options and put options, and wherein the expirations of the call options and put options are different between any two of the plurality of variance portfolios; periodically rebalancing the index portfolio according to a selected sub-period; determining a forward implied variance index value based on current and past values of the plurality of variance portfolios; and generating at least one financial instrument having an instrument value that depends on the current forward implied variance index value.

### BRIEF DESCRIPTION OF THE DRAWINGS

The accompanying drawings illustrate various non-limiting, example, inventive aspects in accordance with the present disclosure:

FIG. 1 shows a schematic illustration of data flows between FIVI components and affiliated entities in one embodiment of FIVI operation;

FIG. 2 shows aspects of FIVI architecture in block-diagram form and data flow between and among FIVI components in one embodiment of FIVI operation;

FIG. 3 shows an exemplary logic flow for forward implied variance index generation and portfolio management in one embodiment of FIVI operation;

FIG. 4 shows an exemplary logic flow for FIVI portfolio construction in one embodiment of FIVI operation;

FIG. 5 shows an exemplary logic flow for forward implied variance index value determination in one embodiment of FIVI operation;

FIG. 6 shows an exemplary logic flow for FIVI index product generation in one embodiment of FIVI operation;

FIG. 7 shows an example of forward implied variance index performance in one embodiment of FIVI operation;

FIG. 8 shows an exemplary logic flow for forward implied variance index generation and portfolio management in another embodiment of FIVI operation; and

FIG. 9 is of a block diagram illustrating embodiments of the FIVI controller.

### DETAILED DESCRIPTION

### FIVI

This disclosure describes methods and systems for generating a forward implied variance index and associated financial products (“FIVI”). Depending on the particular needs and characteristics of a FIVI user and their systems, various embodiments of the FIVI may be implemented that enable a great deal of flexibility and customization.

The instant disclosure discusses embodiments of the FIVI directed to generating, managing, administrating and disseminating forward implied variance indices (e.g., based on an underlying financial index such as the S&P 500), their underlying portfolios, and associated financial products. However, the methods and systems discussed in this disclosure may be readily adapted or reconfigured for a wide variety of other applications. For example, aspects of the FIVI may be adapted for both long and short positions on variance, variances of multiple instruments, and variance of foreign instruments or assets (e.g., individual stocks, currencies, precious metals, commodities, and the like).

In one exemplary embodiment, the FIVI provides exposure to one-month implied variance by implementing a functional strategy that includes creating a portfolio of near-month, second month, and third-month options. Forward variance can provide exposure to implied volatility without significant exposure to realized volatility. Forward variance can be replicated or approximated by maintaining a portfolio of long/short options. To maintain the impliedvolatility exposure on an on-going basis, the FIVI may roll one forward variance into another. The rolling process may be spread over a month-long period, between option expiries, to reduce potential market impact.

In an exemplary embodiment, three portfolios with maturities of one, two, and three months may be established on a first day of the first month. At the expiration of the near-month portfolio, a new portfolio with a maturity of three months may be established. By then, the portfolio with the original maturity of three months will have two months left to maturity, while the portfolio with the original maturity of two months will have one month left to maturity.

In one embodiment, a forward implied variance of an underlying index is calculated. The index may be the S&P 500 Index, the Dow Jones Industrial Average, the Wilshire 5000 Total Market Index, the Russell 2000 Index, or any other suitable index. A 1-month forward starting 1-month variance portfolio may be constructed by going long the second-month portfolio and short the near month portfolio. A two-month forward starting 1-month variance portfolio may be constructed by going long the third-month portfolio and going short the second-month portfolio. At the expiration of each option sub-portfolio, the total portfolio holds 100% of a 1-month forward starting 1-month variance portfolio and 0% in the 2-month forward starting 1-month variance portfolio. Over the next month, the assets of the total portfolio gradually move to 100% in the 2-month forward starting 1-month variance portfolio, which by the endo f the rebalancing process, will become the 1-month forward starting 1-month variance.

In one embodiment, at the end of each day, the index value is calculated as the index value of the previous day multiplied by the daily performance of the weighted sum of the forward implied variances, net of fees.

The FIVI may also be adapted for generating financial products with different positions with respect to variances. Furthermore, aspects of the FIVI may be configured to generate, administer, and manage a wide variety of different financial instruments, securities, and the like beyond the specific embodiments described in detail in this disclosure. For example, indices discussed herein may underlie or be linked to any of a wide variety of financial products, derivatives, instruments, and the like, such as, but not limited to: equities, debts, derivatives, notes (e.g., structured notes), stocks, preferred shares, bonds, treasuries, debentures, options, futures, swaps, rights, warrants, commodities, currencies, funds, long and short positions, ETFs, insurance and risk transfer agreements, annuities, or any other assets or investment interests. The FIVI may be further adapted for use in many other investment, finance, and risk management applications.

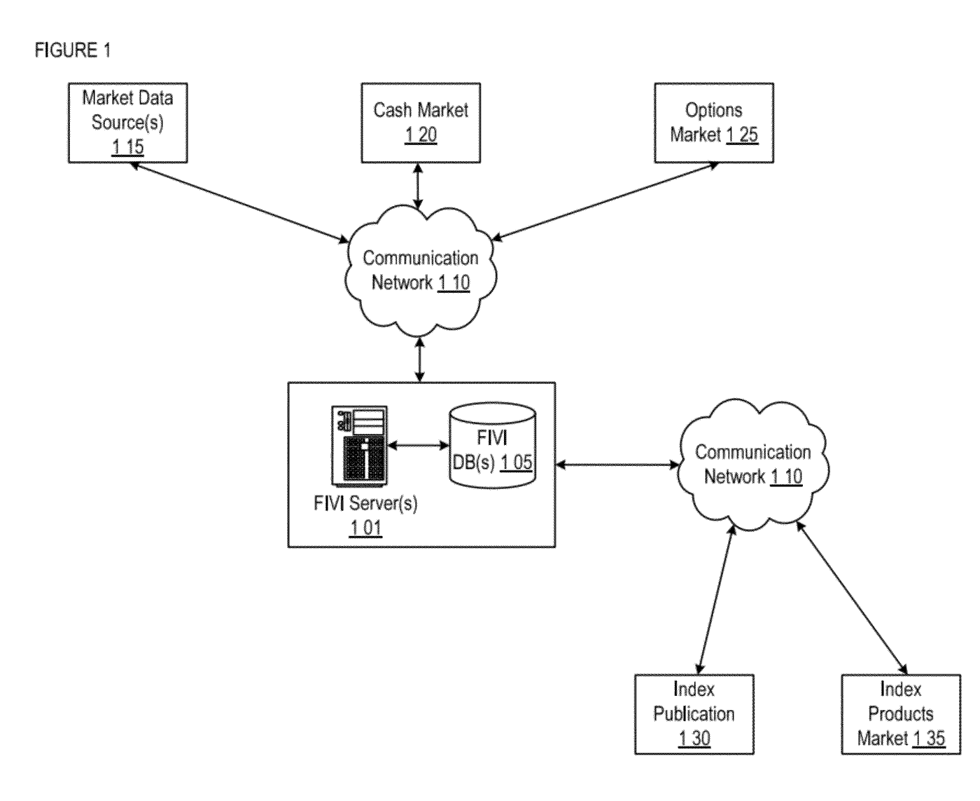

FIG. 1 shows a schematic illustration of data flows between FIVI components and affiliated entities in one embodiment of FIVI operation. The FIVI may, in one implementation, comprise a centralized entity including one or more FIVI servers 101 implementing FIVI functionality and communicatively coupled to one or more FIVI databases (“DBs”) 105 configured to store FIVI data. The FIVI server 101 may be further coupled by a communication network 110 to one or more market data sources 115, such as one or more market data feeds (e.g., Bloomberg's PhatPipe, Dun & Bradstreet, Reuter's Tib, Triarch, and the like) to draw financial data used in the generation and maintenance of FIVI indices. A wide variety of different data may be drawn, such as, but not limited to: current and historical prices of one or more underlying instruments, indices, portfolios, or the like assets, current and historical prices for put and call options on such underlying assets, and the like. The FIVI may process received market data to generate index values or to determine allocations of funds underlying indices to various investments, such as, but not limited to: put and call options on assets having various expiry periods and delta values, and the like. In an implementation where the instruments underlying a FIVI index are to be actually obtained, orders for such investments at the determined levels may be placed by the FIVI with one or more cash market 120 or options market 125 exchanges or with other suitable outlets, such as may include one or both of primary and secondary markets. In another implementation, indices may be based on portfolios that are simulated, synthetic, and the like. In such an implementation, orders may still be placed by the FIVI with one or more cash market 120 or options market 125 exchanges or other suitable outlets to generate financial instruments or initiate a transaction involving financial instruments based on FIVI-generated indices.

Index values associated with the portfolio of investments, real or synthetic, that are generated or administered by the FIVI server 101 may be stored in the FIVI DB 105 for future retrieval, display, report generation, updating, and the like. In one implementation, the FIVI may further provide index values via a communication network 110 for publication 130, such as to a website, to a market data resource, to a ticker, as a report, and the like. The FIVI may further be configured to generate one or more financial instruments with values linked to the value of one or more FIVI generated indices. Such instruments may include, but are not limited to, equities, debts, derivatives, notes (e.g., structured notes), stocks, preferred shares, bonds, treasuries, debentures, options, futures, swaps, rights, warrants, commodities, currencies, funds, long and short positions, ETFs, insurance and risk transfer agreements, annuities, and other assets or investment interests. FIVI generated instruments may then be made available for purchase in one or more index products markets 135.

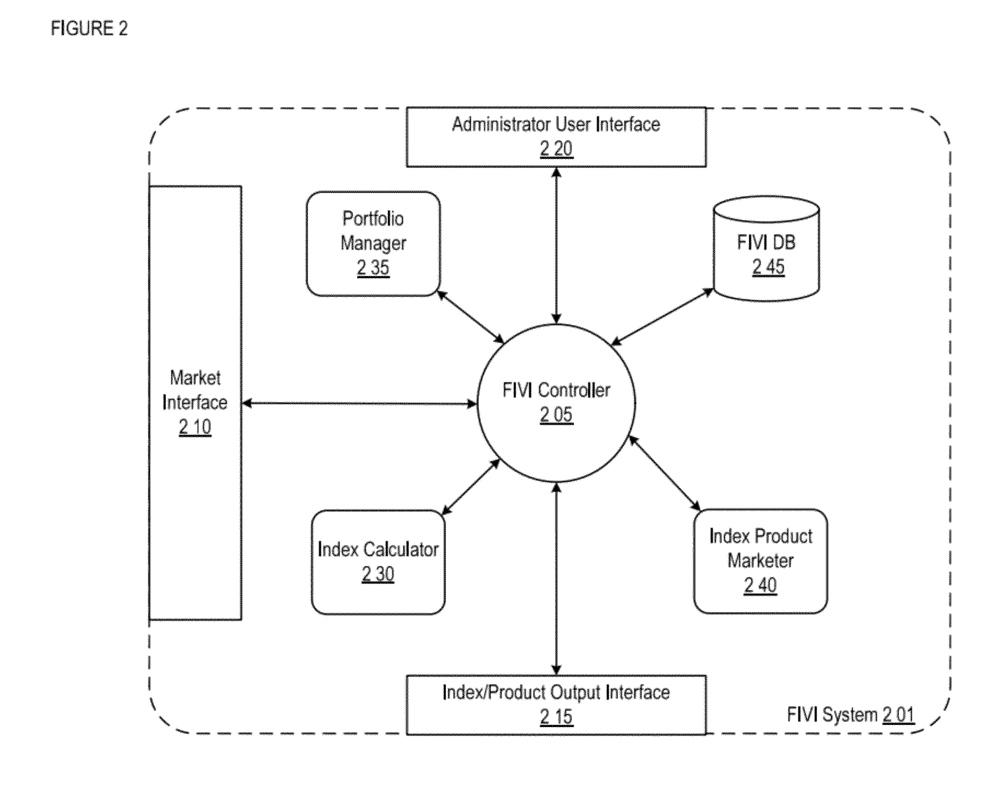

FIG. 2 shows aspects of FIVI architecture in block-diagram form and data flow between and among FIVI components in one embodiment of FIVI operation. A FIVI system 201 may include a number of operational modules and/or data stores configured to carry out FIVI features and/or functionality. A FIVI controller 205 may serve a central role in some embodiments of FIVI operation, serving to orchestrate the reception, generation and distribution of data and/or instructions to, from, and between FIVI modules and to allow further analysis of data generated during FIVI operation. The FIVI controller 205 may be coupled to one or more operational modules configured to implement various features associated with embodiments of FIVI operation.

In one implementation, the FIVI controller 205 may be coupled to a market interface 210 configured to query and/or draw market data from one or more market data sources; place market orders or otherwise effectuate market transactions; receive confirmations of requested instrument transaction fulfillment; and to perform other suitable functions.

In one implementation, the FIVI controller 205 may further be coupled to an index/product output interface 215, which may be configured to publish index values; generate or request generation of reports containing index values and/or the values of associated financial products; generate financial products with values linked to FIVI generated index values; provide FIVI financial products for sale on one or more markets or exchanges; and the like. In one implementation, the FIVI controller 205 may further be coupled to an administrator user interface 220 configured to provide an interface through which an administrator can monitor and interact with FIVI system settings and portfolio allocations, manage data, and the like. For example, in one implementation, a FIVI administrator may interface with the FIVI system via the administrator user interface to adjust the values of index calculation or publication times and other parameters associated with the index, as may be needed or desired within a given application of the FIVI.

In one implementation, the FIVI controller 205 may further be coupled to an index calculator module 230 configured to calculate official index values. In one implementation, the index value may be calculated on a daily basis, such as at the end of each U.S. trading day. In one implementation, daily index closing values may be calculated based on end-of-day values for put and/or call options with specified expiries and delta values at a specified time (e.g., 3:00 PM EST) or at a time that conforms to options market trading practice on a given day.

The index calculator 230 may also be configured to track and monitor values of components of one or more underlying real or simulated FIVI portfolios to and calculate index values based on the value of these components. In one implementation, the index calculator may be configured to calculate forward implied variances for index components, such as for portfolios of call and/or put options with various expiries and deltas. In one implementation, the index calculator module may be configured to determine and access current and past values and variances of one-month, two-month, three-month, and other period option portfolios, wherein each option portfolio comprises a number (e.g., equal number) of call and put options having a predetermined expiry and strike prices delta-wise distributed (e.g., evenly) in a set range (e.g., 1% to 50%). In one implementation, the index calculator module may be further configured to determine one or more weighting factors (e.g., based on ratios of index business days between various endpoints), and to perform weighted sums of portfolio values and/or variances.

In one implementation, the FIVI controller 205 may further be coupled to a portfolio manager module 235 configured to manage one or more portfolios of financial instruments underlying one or more FIVI indices. Such portfolios may, in various implementations, comprise actual investments or be simulated or synthetic portfolios with values tied to specified investments. In one implementation, the portfolio manager module may be configured to administer a portfolio underlying the FIVI index comprising positions on a plurality of options on one or more underlying stocks, bonds, debts and/or debentures, currencies, commodities, real properties, options, indices, portfolios, and like assets. For example, the plurality of options may comprise equal numbers (e.g., 10 each) of calls and puts on the underlying assets with expiries at one period (e.g., one month), two periods, three periods, or any other suitable time period. In one implementation, a FIVI portfolio may comprise various positions on several sub-portfolios of a number of calls and puts, where each sub-portfolio has a different option expiry than each of the other sub-portfolios. For example, a FIVI portfolio may comprise a long position on a two-month variance portfolio and a short position on a one-month variance portfolio, to replicate a one-month forward variance on the underlying assets.

The portfolio manager module 235 may be further configured to implement a rolling rebalancing of the FIVI portfolio to maintain desired portfolio or index characteristics. In one implementation, the portfolio manager may buy or sell shares or portions of FIVI sub-portfolios on a sub-periodic basis (e.g., daily) such that, by the end of a full period (e.g., month), all positions have been shifted to sub-portfolios translated one month ahead. For example, in an implementation where the FIVI portfolio comprises a long position on a two-month variance portfolio and a short position on a one-month variance portfolio, the portfolio manager may buy one unit of the one-month variance portfolio, sell four units of the two-month variance portfolio, and buy three units of a three-month variance portfolio on a daily basis, where the unit is the number of shares in each sub-portfolio divided by the number of index days in the month. Thus, at the end of the month, the FIVI portfolio will comprise a short position in a one-month variance portfolio and a long position in a two-month variance portfolio for the new, upcoming month, after which a new three-month variance portfolio may be established and the rolling rebalancing procedure continued.

In one implementation, the near-period (e.g., one-month) variance portfolio may rebalance five business days before option expiry. In one implementation, options comprising a FIVI portfolio or sub-portfolio may be selected to cover a range of delta values or strike prices. For example, strike prices of the group of options (e.g., calls or puts) may be spaced substantially equally in a range of deltas, such as from 1% delta to 50% delta. In one implementation, strike prices for each group of options may be distributed across a range of strike prices, for example, strike prices may be evenly distributed (e.g., in 1% increments) between 50% and 150% of the price of the underlying assets. In one implementation, a delta-hedge may be applied for each portfolio, in accordance with a derivative pricing model or other formula, such as the Black-Scholes option pricing model. In one implementation, a Black-Sholes option pricing model with a zero risk-free rate and zero dividend assumption may be used, to avoid daily re-striking of the option portfolios. In one implementation, the volatilities used for the delta hedge may be fixed at the time of the strike to the implied volatilities used for the relevant strikes.

In one implementation, the FIVI controller 205 may further be coupled to an index product marketer module 240 configured to generate, market, and manage, financial instruments with values tied to one or more FIVI indices. In various implementations, the index product marketer module may be configured to generate and manage any of a wide variety of different financial products, such as, but not limited to: equities, debts, derivatives, notes (e.g., structured notes), stocks, preferred shares, bonds, treasuries, debentures, options, futures, swaps, rights, warrants, commodities, currencies, funds, long and/or short positions, ETFs, insurance and/or risk transfer agreements, annuities, and other assets or investment interests. In one implementation, the index product marketer module may initiate the formation of a corporation, special purpose entity, fund, and/or the like entity which owns a portfolio underlying a FIVI index and which issues shares with values tied to that index.

In one implementation, the FIVI controller 205 may further be coupled to one or more databases 245 configured to store a variety of data associated with FIVI operation in various embodiments. For example, in one implementation, the FIVI database may include tables for storing information associated with current and/or historical FIVI index values, underlying portfolios and/or portfolio elements, FIVI index linked financial products, market data, transaction orders, transaction histories, and the like. Further detail surrounding such tables is provided below.

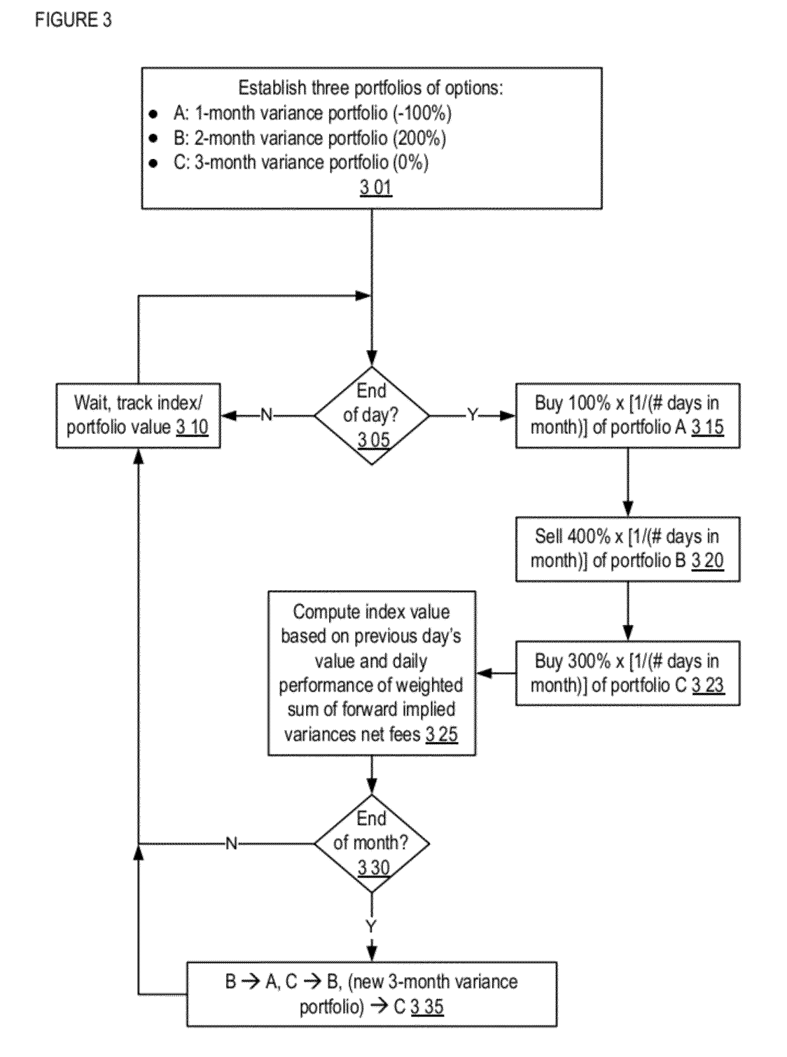

FIG. 3 shows an exemplary logic flow for forward implied variance index generation and portfolio management in one embodiment of FIVI operation. Certain aspects of the logic flow shown in FIG. 3, such as, but not limited to, the period, sub-period, number of sub-portfolios, proportions, and the like are shown for illustrative purposes only. Other values, amounts, compositions, periods, and the like may be employed in other embodiments and implementations. In the illustrated implementation, three portfolios of options are established with different weights to comprise an overall FIVI portfolio 301. Here, there is a short position (−100%) taken in a one-month variance portfolio (portfolio A), a long-position (200%) taken in a two-month variance portfolio (portfolio B), and no initial position taken in a three-month variance portfolio (portfolio C). A determination may then be made as to whether an end of day has been reached 305. If not, then the FIVI may wait and continue to track index and/or portfolio variance, value, and the like, as discussed further below. Once an end of day has been reached at 305, the FIVI may instantiate a rolling rebalancing of the portfolio.

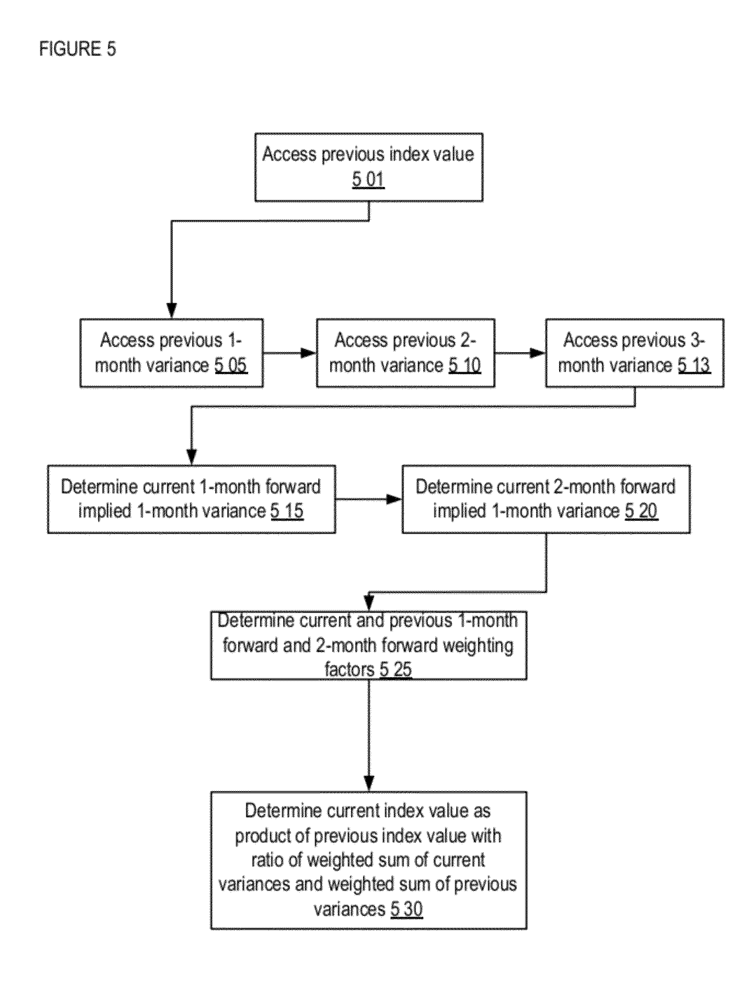

For example, in one implementation, the FIVI may buy one unit of portfolio A 315, sell four units of portfolio B 320, and buy 3 units of portfolio C 323. In one implementation, a unit may be selected such that, by the end of an index period, there is no position in portfolio A, a short position (e.g., −200%) in portfolio B, and a long position (300%) in portfolio C. For example, the unit may comprise the total value of a given portfolio or sub-portfolio divided by the number of index business days in a period. The FIVI may proceed to compute index value based on previous day's value and the daily performance of a weighted sum of forward implied variances for the FIVI portfolio or sub-portfolios 325. In some implementations, index fee determination may proceed in accordance with the flow shown in FIG. 5. In one implementation, net fees may be deducted from daily performance prior to index determination. A determination may then be made as to whether the end of the month has been reached 330. If the end of the month has not yet been reached, the FIVI may wait and continue to track FIVI portfolios and sub-portfolios.

When the end of the month has been reached at 330, the FIVI may roll over designations of existing sub-portfolios and generate new sub-portfolios in anticipation of the next month's index administration. For example, portfolio B may become portfolio A. That is, a month after the two-month variance portfolio was established, it has become a one-month variance portfolio. Similarly, portfolio C may become portfolio B, and a new portfolio C (a new three-month variance portfolio) may be established 335.

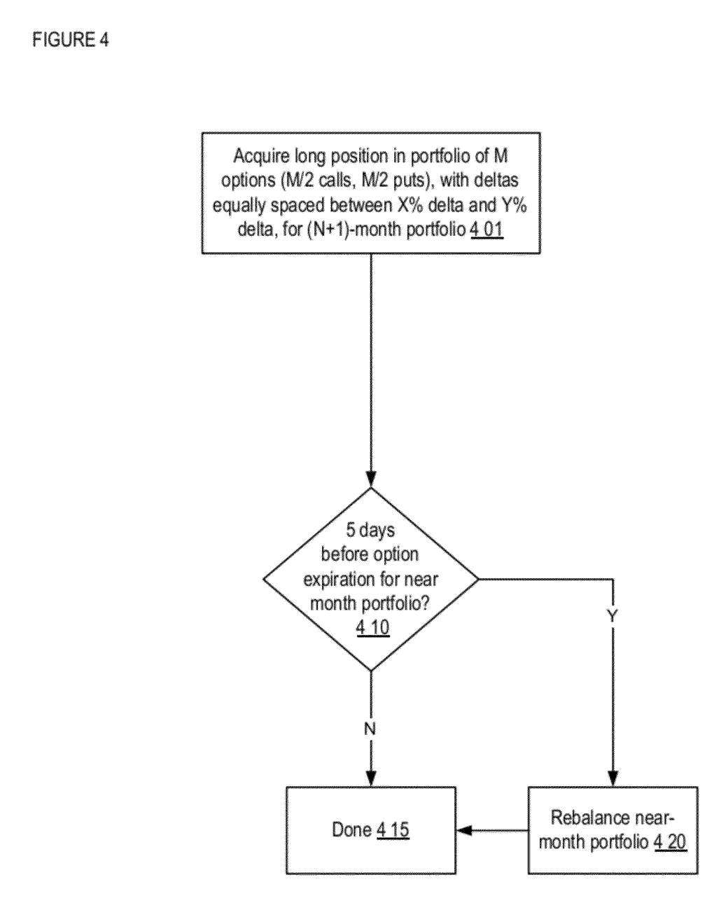

FIG. 4 shows an exemplary logic flow for FIVI portfolio construction in one embodiment of FIVI operation. A flow similar to that shown in the example of FIG. 4 may be employed in various embodiments of FIVI operation for construction of FIVI portfolios, sub-portfolios, and other portfolio elements components. The FIVI may acquire a long position in a (N+1)-period (e.g., month) portfolio of M options, wherein the portfolio comprises M/2 calls and M/2 puts. In one implementation, M is equal or substantially close to 20. In one implementation, options comprising a FIVI portfolio are European-style options. In one implementation, the number of calls may not be equal to the number of puts. In one implementation, options comprising a FIVI portfolio or sub-portfolio may have deltas selected from a delta range (X % to Y %). For example, options may have deltas in a range from 1% delta to 50% delta. In one implementation, option deltas may be substantially evenly spaced and/or uniformly distributed in the delta range. Options may also be configured to have strike prices selected from a strike range (e.g., 50% to 150%). In one implementation, strike prices may be substantially evenly spaced and/or uniformly distributed in the strike range (e.g., incrementing by 1%). A determination may be made as to whether there are 5 days before the option expiration for a near period (e.g., one month) portfolio 410. If so, then the near-period portfolio may be rebalanced 420. Otherwise, the flow may conclude 415, and/or the FIVI may wait for a period of time before rechecking the number of days before option expiration 410.

FIG. 5 shows an exemplary logic flow for forward implied variance index value determination in one embodiment of FIVI operation. In some implementations, aspects of a flow similar to that shown in the example of FIG. 5 may be employed by the FIVI to determine index values. The FIVI may access a prior index value 501, such as the value of the index on the previous day, the value (e.g., normalized) of the index on its inception day, or the like. The FIVI may further access prior values and/or variances associated with the one-month variance portfolio 505, two-month variance portfolio 510, and three-month variance portfolio 513. The FIVI may then determine a current one-month forward implied one-month variance 515 and a current two-month forward implied one-month variance 520 based on a weighted sum of the accessed portfolio variances. In one exemplary embodiment, such a weighted sum may be calculated using the following formula:

Variance_{T}_{₁}_{,T}_{₂}(t)=F_{T}_{₁}_{,T}₂(t, T₂)Portfolio_{T}_{₂}(t)−F_{T}_{₁}_{,T}_{₂}(t, T₁)Portfolio_{T}_{₁}(t)

Where Portfolio_{TN}(t) is the value and/or variance of the N-period portfolio at time t, and where,

$${F}_{{T}_{X} , {T}_{Y}} ( t , {T}_{N} ) = \frac{BusinessDays ( t , {T}_{N} )}{BusinessDays ( {T}_{X} , {T}_{Y} )}$$

The FIVI may then determine current (e.g., at t) and previous (e.g., at t-1) one-month forward and two-month forward weighting factors, roll weights, and/or the like 525. In one implementation, one-month forward and two-month forward weighting factors may, respectively, take forms similar to the following examples:

$${RW}_{{T}_{1} , {T}_{2}} ( t ) = \frac{BusinessDays ( t , {T}_{1} )}{BusinessDays ( r , {T}_{1} )}$$

$${RW}_{{T}_{2} , {T}_{3}} ( t ) = 1 - {RW}_{{T}_{1} , {T}_{2}} ( t )$$

Where r is the first valuation day of the current roll period. The FIVI may then determine a current index value as a product of the prior index value with a ratio of a weighted sum of current variances and a weighted sum of prior variances 530. For example, in one implementation, the current index value may be calculated using the following formula:

$$IndexValue ( t ) = IndexValue ( t - 1 ) \times \frac{{RW}_{{T}_{1} , {T}_{2}} ( t - 1 ) \times {Variance}_{{T}_{1} , {T}_{2}} ( t ) + {RW}_{{T}_{2} , {T}_{3}} ( t - 1 ) \times {Variance}_{{T}_{2} , {T}_{3}} ( t )}{\begin{matrix}{RW}_{{T}_{1} , {T}_{2}} ( t - 1 ) \times {Variance}_{{T}_{1} , {T}_{2}} ( t - 1 ) + \\ {RW}_{{T}_{2} , {T}_{3}} ( t - 1 ) \times {Variance}_{{T}_{2} , {T}_{3}} ( t - 1 )\end{matrix}}$$

An exemplary embodiment of the methods and parameters used to calculate a forward implied variance index value is shown in Table 1. The methodology shown is illustrative only and is not meant to limit the The FIVI may used other suitable methods not shown in Table 1.

TABLE 1

| | |
|---|---|
| Underlying: | [S&P 500] |
| Target | [1 month] |
| Periodicity: | |
| Option | Every third Saturday of each month, or as published by the Options Clearing |
| Expiration | Corporation |
| Day: | |
| T₁: | One Index Business Day before the immediately following Option Expiration Day |
| T₂: | One Index Business Day before the second immediately following Option Expiration |
| | Day |
| T₃: | One Index Business Day before the third immediately following Option Expiration Day |
| Valuation | Daily, provided that it is an Index Business Day |
| Days: | |
| Roll Periods: | Roll Periods start from, and excluding, [five] Index Business Day before each Option |
| | Expiration Day to, and including, [five] Index Business Day before the immediately |
| | following Option Expiration Day. |
| Determination | On the last day of a Roll Period, a new Spot Portfolio with maturity on T₃ (“Portfolio(T₃)”) |
| of Portfolio_{T1}, | is established. What was Portfolio(T₃) during the current Roll Period becomes |
| Portfolio_{T2} | Portfolio(T₂) for the next Roll Period and what was Portfolio(T₂) during the current Roll |
| and | Period becomes Portfolio(T₁) for the next Roll Period |
| Portfolio_{T3} | |
| Index Value ₜ: | The Index Value as of the Initial Valuation Date is equal to [100]%. Thereafter, “Index |
| | Value ₜ” as of Valuation Day t is calculated as follows: |
| | $( IndexValue ( t ) = IndexValue ( t - 1 ) \times \frac{{RW}_{{T}_{1} , {T}_{2}} ( t - 1 ) \times {Variance}_{{T}_{1} , {T}_{2}} ( t ) + {RW}_{{T}_{2} , {T}_{3}} ( t - 1 ) \times {Variance}_{{T}_{2} , {T}_{3}} ( t )}{{RW}_{{T}_{1} , {T}_{2}} ( t - 1 ) \times {Variance}_{{T}_{1} , {T}_{2}} ( t - 1 ) + {RW}_{{T}_{2} , {T}_{3}} ( t - 1 ) \times {Variance}_{{T}_{2} , {T}_{3}} ( t - 1 )} )$ |
| Roll Weights: | ${RW}_{{T}_{1} , {T}_{2}} ( t ) = \frac{BusinessDays ( t , {T}_{1} )}{BusinessDays ( r , {T}_{1} )}$ |
| | RW_{T}_{₂}_{,T}_{₃}(t) = 1 − RW_{T}_{₁}_{,T}_{₂}(t) |
| | where |
| | “BusinessDays(t, T₁)” means the number of Index Business Days from, and including, |
| | Valuation Day t, to, and including, Valuation Day T₁; |
| | “BusinessDays(r, T₁)” means the number of Index Business Days from, and including, |
| | Valuation Day r, which is the first Valuation Day of the current Roll Period, to, and |
| | including, Valuation Day T₁; |
| Implied Forward | Variance_{T}_{₁}_{,T}_{₂}(t) = F_{T}_{₁}_{,T}_{₂}(t,T₂)Portfolio_{T}_{₂}(t) − F_{T}_{₁}_{,T}_{₂}(t,T₁)Portfolio_{T}_{₁}(t) |
| Variance between | where |
| T₁ and T₂ on | “F_{T}_{₁}_{,T}_{₂}(t, T₂)” is defined below; |
| Valuation Day t: | “Portfolio_{T}_{₂}(t)” means value of the Portfolio(T₂) on Valuation Day t; |
| | “F_{T}_{₁}_{,T}_{₂}(t, T₁)” is defined below; |
| | “Portfolio_{T}_{₁}(t)” means value of the Portfolio(T₁) on Valuation Day t |
| Implied Forward | Variance_{T}_{₂}_{,T}_{₃}(t) = F_{T}_{₂}_{,T}_{₃}(t,T₃)Portfolio_{T}_{₃}(t) − F_{T}_{₂}_{,T}_{₃}(t,T₂)Portfolio_{T}_{₂}(t) |
| Variance between | where |
| T₂ and T₃ on | “F_{T}_{₂}_{,T}_{₂}(t, T₃)” is defined below; |
| Valuation Day t: | “Portfolio_{T}_{₃}(t)” means value of the Portfolio(T₃) on Valuation Day t; |
| | “F_{T}_{₂}_{,T}_{₃}(t, T₂)” is defined below; |
| | “Portfolio_{T}_{₂}(t)” means value of the Portfolio(T₂) on Valuation Day t |
| Time Scaling Factors: | ${F}_{{T}_{2} , {T}_{3}} ( t , {T}_{3} ) = \frac{BusinessDays ( t , {T}_{3} )}{BusinessDays ( {T}_{2} , {T}_{3} )}$ ${F}_{{T}_{2} , {T}_{3}} ( t , {T}_{2} ) = \frac{BusinessDays ( t , {T}_{2} )}{BusinessDays ( {T}_{2} , {T}_{3} )}$ ${F}_{{T}_{1} , {T}_{2}} ( t , {T}_{2} ) = \frac{BusinessDays ( t , {T}_{2} )}{BusinessDays ( {T}_{1} , {T}_{2} )}$ ${F}_{{T}_{1} , {T}_{2}} ( t , {T}_{1} ) = \frac{BusinessDays ( t , {T}_{1} )}{BusinessDays ( {T}_{1} , {T}_{2} )}$ |
| | where |
| | “BusinessDays(t, T₁)” means the number of Index Business Days from, but excluding, |
| | Valuation Day t, to, and including, Valuation Day T₁; |
| | “BusinessDays(t, T₂)” means the number of Index Business Days from, but excluding, |
| | Valuation Day t, to, and including, Valuation Day T₂; |
| | “BusinessDays(t, T₃)” means the number of Index Business Days from, but excluding, |
| | Valuation Day t, to, and including, Valuation Day T₃; |
| | “BusinessDays(T₁, T₂)” means the number of Index Business Days from, but excluding, |
| | Valuation Day T₁ to, and including, Valuation Day T₂; |
| | “BusinessDays(T₂, T₃)” means the number of Index Business Days from, but excluding, |
| | Valuation Day T₂ to, and including, Valuation Day T₃ |
| Spot Portfolio: | The portfolio tracking implied variance between Valuation Day t and Valuation Day T, |
| | “Portfolio_{T}(t)”, is calculated, from the bid/ask prices of calls/puts with the following |
| | deltas: 1%, 6%, 12%, 17%, 23%, 28%, 34%, 39%, 45%, 50% |
| | of Underlying with the same expiry, as: |
| | ${Portfolio}_{T} ( t ) = \frac{2 \times 252}{BusinessDays ( t , T )} {\sum }_{i = 1}^{20} ( \frac{Δ {K}_{i} ( r )}{{{K}_{i} ( r )}^{2}} [ {Q}_{{K}_{i} ( r )} ( t ) + {DH}_{{K}_{i} ( r )} ( t ) ] )$ |
| | where |
| | “Kᵢ(r)” means strike price, as % of S(r), of the i-th option as determined on the |
| | immediately preceding Rebalance Day r; |
| | “S(r)” means the Official Closing Level of the Underlying on Valuation Day r; |
| | “ΔKᵢ(r)” means |
| | $\frac{[ {K}_{i + 1} ( r ) - {K}_{i 1} ( r ) ]}{2} ,$ |
| | provided that at the upper and lower edges of the |
| | given strip of options, ΔKᵢ(r) is simply the difference between Kᵢ(r) and the adjacent |
| | strike price; |
| | “QKᵢ(r)(t)” means bid/ask price, as % of S(r), for the i-th option; |
| | “DHKᵢ(r)(t)” means the Delta Hedge P&L of the i-th option |
| Delta Hedge | The delta hedge P&L of the i-th option, struck on Valuation Day r, on Valuation Day t, |
| P&L: | DHKᵢ(r)(t), is determined according to the following formulae: |
| | ${DHK}_{i} ( r ) ( t ) = \frac{1}{S ( r )} {\sum }_{j = r + 1}^{t} ( {\overline{Δ}}_{i} ( j ) - {Δ}_{i} ( j ) ) \times ( S ( j ) - S ( j - 1 ) )$ |
| | where |
| | “S(j)” means the Official Closing Level of the Underlying on Valuation Day j; |
| | “Δᵢ(j)” means |
| | $N ( ( ln ( S ( j ) \text{/} {K}_{i} ( r ) \text{/} S ( r ) ) + 0.5 \times {{σ}_{i} ( r )}^{2} \times BusinessDays ( j , T ) \text{/} 252 ) \text{/} ( {σ}_{i} ( r ) \sqrt{BusinessDays ( j , T ) \text{/} 252} ) )$ |
| | “ Δ̅ᵢ(j)” means |
| | $N ( ( ln ( 1 \text{/} {K}_{i} ( r ) ) + 0.5 \times {{σ}_{i} ( r )}^{2} \times BusinessDays ( j , T ) \text{/} 252 ) \text{/} ( {σ}_{i} ( r ) \sqrt{BusinessDays ( j , T ) \text{/} 252} ) )$ |
| | “N(x)” means the “Normal Cumulative Distribution Function” as determined by |
| | Calculation Agent; |
| | “σᵢ(r)” means the implied volatility of the i-th option on Valuation Day r, as determined |
| | by Calculating Agent |
| Index Business | New York |
| Days: | |
| Business Day | Modified Following |
| Convention: | |

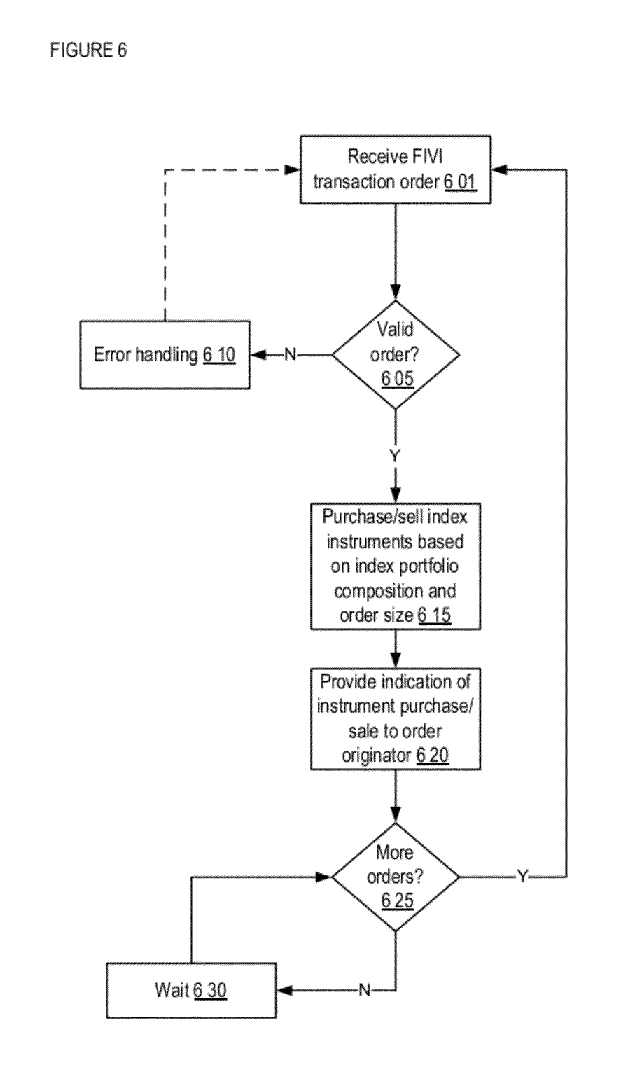

FIG. 6 shows aspects of logic flow for FIVI index product generation in one embodiment of FIVI operation. The FIVI may receive a transaction order, such as may specify an index, a transaction instruction (e.g., purchase, sale, transaction timing or phases, and the like) and a transaction value, such as a number of shares, amount of cash, and the like 601. In one implementation, a transaction order may further specify a payment method and/or mechanism, account identification, user identification, authentication information, and the like. A determination may be made as to whether the order is valid 605. Such a determination may be based on a wide variety of different criteria in different implementations, such as the presence of sufficient information in the order to unambiguously effectuate the order, the successful authentication of the order originator, the availability and feasibility of the order, and the like. If the order is invalid, an error handling procedure may be undertaken 610, such as requesting that the order originator modify and/or resubmit the order. If a valid order is received, the FIVI may purchase, sell, or otherwise transact instruments based on the composition of a portfolio corresponding to an index specified in the transaction order, where the amount of instruments transacted is based on the size of the order 615.

The FIVI may further provide an indication of the instrument transaction to the order originator 620, such as may comprise a transaction confirmation, a collection of shares, an account update, and the like. A determination may be made as to whether additional orders exist 625. If not, then the FIVI may wait for a period of time 630 before checking again for further orders. If more orders are to be made, the FIVI may return to 601.

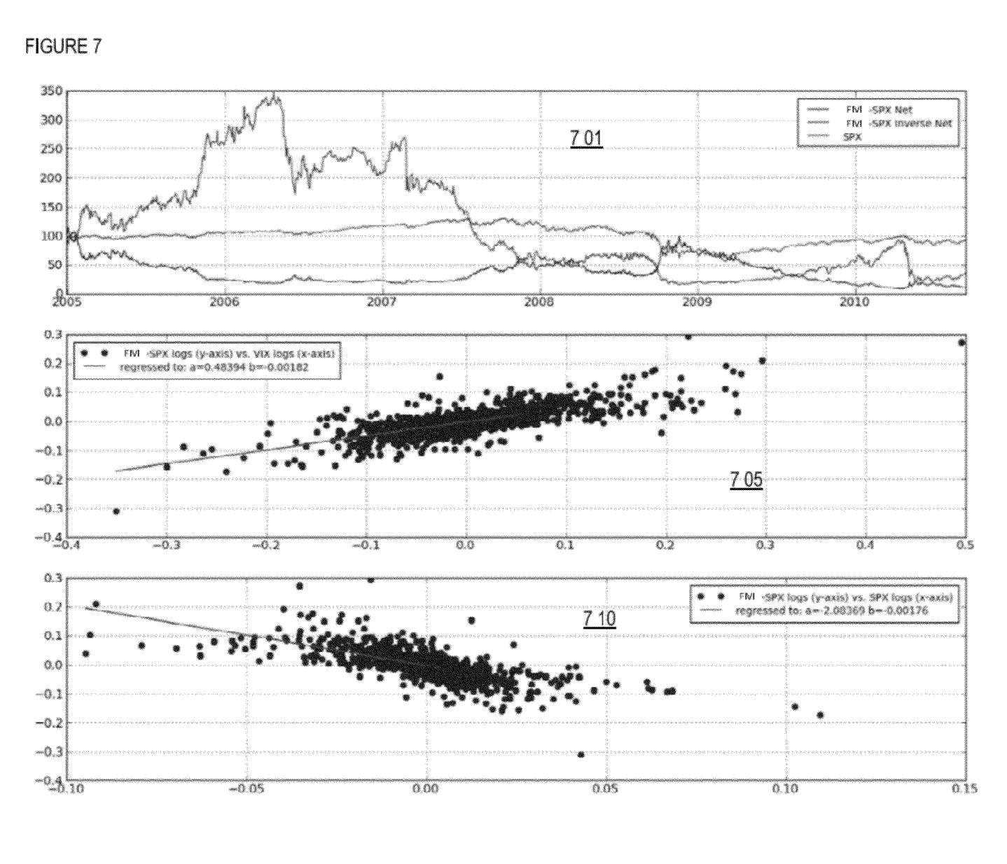

FIG. 7 shows an example of forward implied variance index performance in one embodiment of FIVI operation. In the illustrated implementation, the underlying asset for the FIVI index is the S&P 500 index (SPX), and the two are shown together, along with the inverse net of the FIVI index, at 701. The illustrated implementation also shows correlation plots for the FIVI index versus the Chicago Board Options Exchange Volatility Index (VIX) 705, and the FIVI index versus SPX 710.

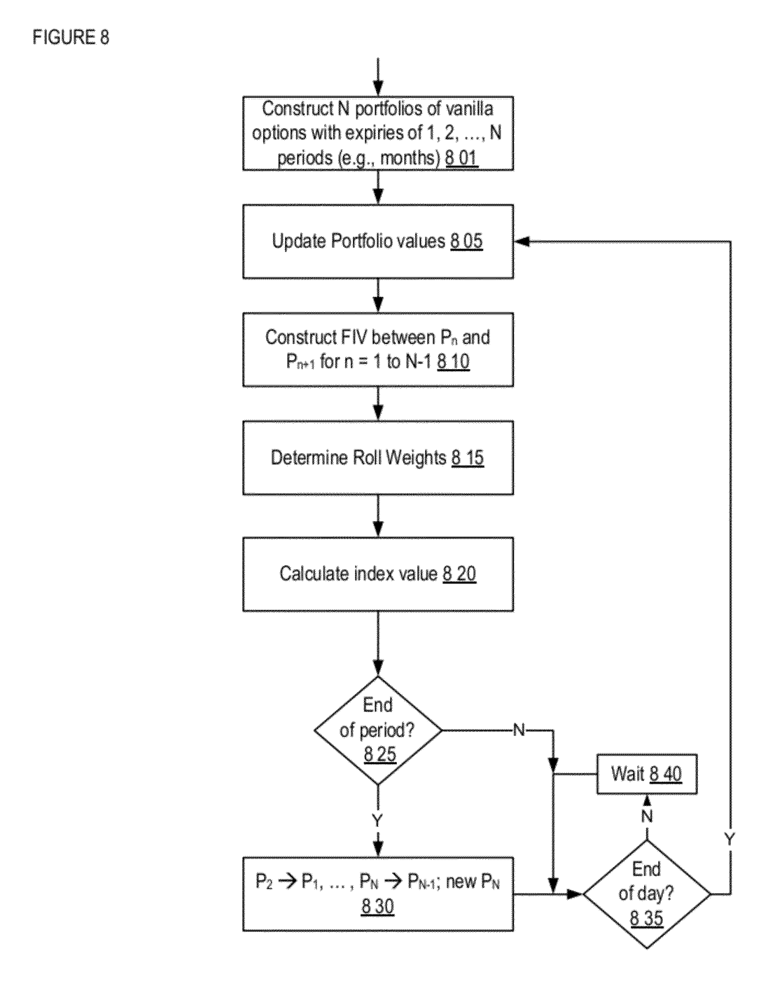

FIG. 8 shows an exemplary logic flow for forward implied variance index generation and portfolio management in another embodiment of FIVI operation. A plurality of N portfolios may be constructed, where the ith portfolio comprises vanilla options with expiries i periods (e.g., months) in the future 801. In one implementation, each portfolio of the plurality of portfolios may comprise an equal number of call options and put options. In one implementation, N may be three. Once portfolios have been constructed, the FIVI may update portfolio values according to at least one of a variety of alternative approaches 805.

For example, in one implementation, each portfolio may be updated by selling all options in the portfolio and buying new options with recalculated strikes. In another implementation, each portfolio may be updated by calculating the delta of each option in the portfolio and selling the underlying stocks, futures, and the like of the delta amount. In still another implementation, each portfolio may be updated by calculating a current delta of each of the current options held, calculating a recalculated delta of each of the options with recalculated strikes, and buying underlying stocks, futures, and the like of the amount equal to the difference between the recalculated delta and the current delta. The FIVI may then construct one or more forward implied variances between the different expiry portfolios 810.

For example, in one implementation, a forward implied variance may be constructed between each portfolio and the portfolio having expiry closest to but greater than that portfolio's expiry. In one implementation, forward implied variances may be determined as weighted sums and/or differences between values, implied variances, and the like corresponding to each portfolio, as described in greater detail above. The FIVI may then determine roll weights 815 for each forward implied variance, for example, in accordance with the formulas discussed above, and may calculate an index value 820, such as by using one or more current and or previous forward implied variances, current or previous rolling weights, previous and/or initial index values, and the like. In one implementation, the index value may be determined in accordance with implementations discussed above (e.g., with reference to 530 in FIG. 5).

A determination may then be made as to whether an end of period has been reached 825. In one implementation, an end of period may be reached a predetermined number of days, business days, index business days, or the like (e.g., five index business days) prior to the expiry of the nearest period portfolio. If so, then a new farthest period (e.g., Nth) portfolio may be established, and each ith portfolio may be relabeled as the (i-1)th portfolio. A determination may be made as to whether an end of day has been reached 835 and, if not, then the FIVI may wait for a period of time 840 before rechecking. If an end of day has been reached at 835, the FIVI may return to 805 for portfolio value updating.

### FIVI Controller

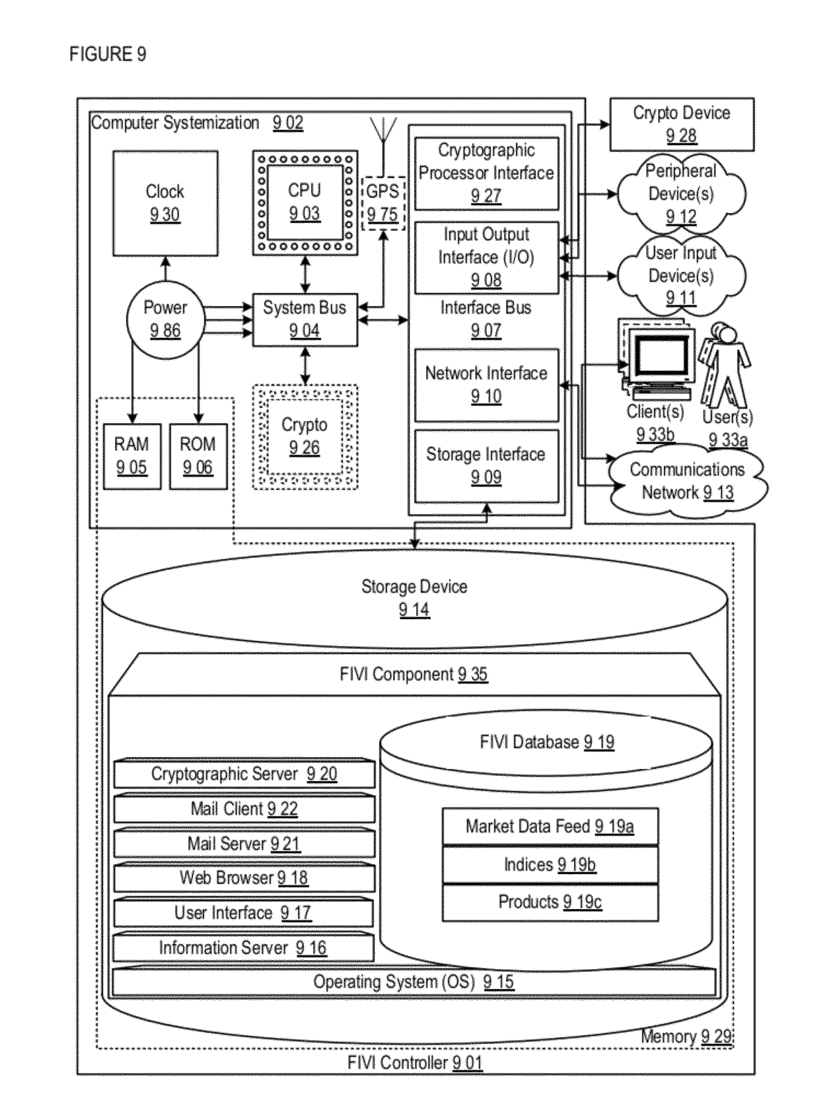

FIG. 9 illustrates inventive aspects of a FIVI controller 901 in a block diagram. In this embodiment, the FIVI controller 901 may serve to aggregate, process, store, search, serve, identify, instruct, generate, match, and/or facilitate interactions with a computer through forward implied variance index and associated financial product generation and management technologies, and/or other related data.

Typically, users, which may be people and/or other systems, may engage information technology systems (e.g., computers) to facilitate information processing. In turn, computers employ processors to process information; such processors 903 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 929 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the FIVI controller 901 may be connected to and/or communicate with entities such as, but not limited to: one or more users from user input devices 911; peripheral devices 912; an optional cryptographic processor device 928; and/or a communications network 913.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The FIVI controller 901 may be based on computer systems that may comprise, but are not limited to, components such as: a computer systemization 902 connected to memory 929.

### Computer Systemization

A computer systemization 902 may comprise a clock 930, central processing unit (“CPU(s)” and/or “processor(s)” (these terms are used interchangeable throughout the disclosure unless noted to the contrary)) 903, a memory 929 (e.g., a read only memory (ROM) 906, a random access memory (RAM) 905, etc.), and/or an interface bus 907, and most frequently, although not necessarily, are all interconnected and/or communicating through a system bus 904 on one or more (mother)board(s) 902 having conductive and/or otherwise transportive circuit pathways through which instructions (e.g., binary encoded signals) may travel to effect communications, operations, storage, etc. Optionally, the computer systemization may be connected to an internal power source 986. Optionally, a cryptographic processor 926 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the FIVI controller and beyond through various interfaces. Should processing requirements dictate a greater amount speed and/or capacity, distributed processors (e.g., Distributed FIVI), mainframe, multi-core, parallel, and/or super-computer architectures may similarly be employed.Alternatively, should deployment requirements dictate greater portability, smaller Personal Digital Assistants (PDAs) may be employed.

Depending on the particular implementation, features of the FIVI may be achieved by implementing a microcontroller such as CAST's R8051XC2 microcontroller; Intel's MCS 51 (i.e., 8051 microcontroller); and/or the like. Also, to implement certain features of the FIVI, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the FIVI component collection (distributed or otherwise) and/or features may be implemented via the microprocessor and/or via embedded components; e.g., via ASIC, coprocessor, DSP, FPGA, and/or the like. Alternately, some implementations of the FIVI may be implemented with embedded components that are configured and used to achieve a variety of features or signal processing.

Depending on the particular implementation, the embedded components may include software solutions, hardware solutions, and/or some combination of both hardware/software solutions. For example, FIVI features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the FIVI features. A hierarchy of programmable interconnects allow logic blocks to be interconnected as needed by the FIVI system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the FIVI may be developed on regular FPGAs and then migrated into a fixed version that more resembles ASIC implementations. Alternate or coordinating implementations may migrate FIVI controller features to a final ASIC instead of or in addition to FPGAs. Depending on the implementation all of the aforementioned embedded components and microprocessors may be considered the “CPU” and/or “processor” for the FIVI.

### Power Source

The power source 986 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 986 is connected to at least one of the interconnected subsequent components of the FIVI thereby providing an electric current to all subsequent components. In one example, the power source 986 is connected to the system bus component 904. In an alternative embodiment, an outside power source 986 is provided through a connection across the I/O 908 interface. For example, a USB and/or IEEE 1394 connection carries both data and power across the connection and is therefore a suitable source of power.

### Interface Adapters

Interface bus(ses) 907 may accept, connect, and/or communicate to a number of interface adapters, conventionally although not necessarily in the form of adapter cards, such as but not limited to: input output interfaces (I/O) 908, storage interfaces 909, network interfaces 910, and/or the like. Optionally, cryptographic processor interfaces 927 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 909 may accept, communicate, and/or connect to a number of storage devices such as, but not limited to: storage devices 914, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 910 may accept, communicate, and/or connect to a communications network 913. Through a communications network 913, the FIVI controller is accessible through remote clients 933b (e.g., computers with web browsers) by users 933a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed FIVI), architectures may similarly be employed to pool, load balance, and/or otherwise increase the communicative bandwidth required by the FIVI controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 910 may be used to engage with various communications network types 913. For example, multiple network interfaces may be employed to allow for the communication over broadcast, multicast, and/or unicast networks.

Input Output interfaces (I/O) 908 may accept, communicate, and/or connect to user input devices 911, peripheral devices 912, cryptographic processor devices 928, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 911 may be card readers, dongles, finger print readers, gloves, graphics tablets, joysticks, keyboards, mouse (mice), remote controls, retina readers, trackballs, trackpads, and/or the like.

Peripheral devices 912 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the FIVI controller may be embodied as an embedded, dedicated, and/or monitor-less (i.e., headless) device, wherein access would be provided over a network interface connection.

Cryptographic units such as, but not limited to, microcontrollers, processors 926, interfaces 927, and/or devices 928 may be attached, and/or communicate with the FIVI controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 929. However, memory is a fungible technology and resource, thus, any number of memory embodiments may be employed in lieu of or in concert with one another. It is to be understood that the FIVI controller and/or a computer systemization may employ various forms of memory 929. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 929 will include ROM 906, RAM 905, and a storage device 914. A storage device 914 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 929 may contain a collection of program and/or database components and/or data such as, but not limited to: operating system component(s) 915 (operating system); information server component(s) 916 (information server); user interface component(s) 917 (user interface); Web browser component(s) 918 (Web browser); database(s) 919; mail server component(s) 921; mail client component(s) 922; cryptographic server component(s) 920 (cryptographic server); the FIVI component(s) 935; and/or the like (i.e., collectively a component collection). These components may be stored and accessed from the storage devices and/or from storage devices accessible through an interface bus. Although non-conventional program components such as those in the component collection, typically, are stored in a local storage device 914, they may also be loaded and/or stored in memory such as: peripheral devices, RAM, remote storage facilities through a communications network, ROM, various forms of memory, and/or the like.

### Operating System

The operating system component 915 is an executable program component facilitating the operation of the FIVI controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the FIVI controller to communicate with other entities through a communications network 913. Various communication protocols may be used by the FIVI controller as a subcarrier transport mechanism for interaction, such as, but not limited to: multicast, TCP/IP, UDP, unicast, and/or the like.

### Information Server

An information server component 916 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the FIVI controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the FIVI database 919, operating systems, other program components, user interfaces, Web browsers, and/or the like.

Access to the FIVI database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the FIVI. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the FIVI as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 917 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 918 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the FIVI enabled nodes. The combined application may be nugatory on systems employing standard Web browsers.

### Mail Server

A mail server component 921 is a stored program component that is executed by a CPU 903. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the FIVI.

Access to the FIVI mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 922 is a stored program component that is executed by a CPU 903. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 920 is a stored program component that is executed by a CPU 903, cryptographic processor 926, cryptographic processor interface 927, cryptographic processor device 928, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the FIVI may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the FIVI component to engage in secure transactions if so desired. The cryptographic component facilitates the secure accessing of resources on the FIVI and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The FIVI Database

The FIVI database component 919 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the FIVI database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the FIVI database is implemented as a data-structure, the use of the FIVI database 919 may be integrated into another component such as the FIVI component 935. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 919 includes several tables 919a-c. A market data table 919a may include fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi. An indices table 919b may include fields such as, but not limited to: index_ID, index_name, components, values, history, portfolio_ID, portfolio_components, portfolio_weights, portfolio_values, product_ID(s), restrictions and/or authorizations, index_profile, and/or the like. A products table 919c may include fields such as, but not limited to: product_ID, product_name, index_ID(s), terms, restrictions, transaction_history, values, chain_of_title, and/or the like.

In one embodiment, the FIVI database may interact with other database systems. For example, employing a distributed database system, queries and data access by search FIVI component may treat the combination of the FIVI database, an integrated data security layer database as a single database entity.

In one embodiment, user programs may contain various user interface primitives, which may serve to update the FIVI. Also, various accounts may require custom database tables depending upon the environments and the types of clients the FIVI may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 919a-c. The FIVI may be configured to keep track of various settings, inputs, and parameters via database controllers.

The FIVI database may communicate to and/or with other components in a component collection, including itself, and/or facilities of the like. Most frequently, the FIVI database communicates with the FIVI component, other program components, and/or the like. The database may contain, retain, and provide information regarding other nodes and data.

### The FIVIs

The FIVI component 935 is a stored program component that is executed by a CPU. In one embodiment, the FIVI component incorporates any and/or all combinations of the aspects of the FIVI that was discussed in the previous figures. As such, the FIVI affects accessing, obtaining and the provision of information, services, transactions, and/or the like across various communications networks.

The FIVI component enables the determination of weights for constituents of index-linked financial portfolios, the acquisition and/or maintenance/management of those constituents, the determination of market values and/or returns associated with the indices, the generation of financial products based on the indices, and/or the like and use of the FIVI.

The FIVI component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the FIVI server employs a cryptographic server to encrypt and decrypt communications. The FIVI component may communicate to and/or with other components in a component collection, including itself, and/or facilities of the like. Most frequently, the FIVI component communicates with the FIVI database, operating systems, other program components, and/or the like. The FIVI may contain, communicate, generate, obtain, and/or provide program component, system, user, and/or data communications, requests, and/or responses.

### Distributed FIVIs

The structure and/or operation of any of the FIVI node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the FIVI controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment. The following resources may be used to provide example embodiments regarding SOAP parser implementation:
http://www.xay.com/perl/site/lib/SOAP/Parser.html
http://publib.boulder.ibm.com/infocenter/tivihelp/v2r1/index.jsp?topic=/com.ibm.IBMDI.doc/referenceguide295.htm

and other parser implementations:
http://publib.boulder.ibm.com/infocenter/tivihelp/v2r1/index.jsp?topic=/com.ibm.IBMDI.doc/referenceguide259.htm

all of which are hereby expressly incorporated by reference.

To address various issues related to, and improve upon, previous work, the application is directed to METHODS AND SYSTEMS FOR GENERATING A FORWARD IMPLIED VARIANCE INDEX AND ASSOCIATED FINANCIAL PRODUCTS. The entirety of this application (including the Cover Page, Title, Headings, Field, Background, Summary, Brief Description of the Drawings, Detailed Description, Claims, Abstract, Figures, and any other portion of the application) shows by way of illustration various embodiments. The advantages and features disclosed are representative; they are not exhaustive or exclusive. They are presented only to assist in understanding and teaching the claimed principles. It should be understood that they are not representative of all claimed inventions. As such, certain aspects of the invention have not been discussed herein. That alternate embodiments may not have been presented for a specific portion of the invention or that further undescribed alternate embodiments may be available for a portion of the invention is not a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the invention. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functionality, features, logical aspects, organizational aspects, structural aspects, topological aspects, and other aspects of the disclosure are not to be considered limitations on the disclosure as defined by the claims or limitations on equivalents to the claims.

Depending on the particular needs and/or characteristics of a FIVI user, index underlying assets, financial product issuer, applicable market, market data source(s), index configuration, financial advisor, individual and/or enterprise user, database configuration and/or relational model, data type, data transmission and/or network framework, syntax structure, and/or the like, various embodiments of the FIVI may be implemented that enable a great deal of flexibility and customization. This disclosure discusses embodiments and/or applications of the FIVI directed to generating, managing, administrating disseminating forward implied variance indices (e.g., based on a financial index such as the S&P 500), their underlying portfolios and/or associated financial products. However, it is to be understood that the apparatuses, methods and systems discussed herein may be readily adapted and/or reconfigured for a wide variety of other applications and/or implementations. For example, aspects of the FIVI may be adapted for both and/or either long and/or short positions on variance, variances of multiple and/or foreign instruments or assets (e.g., individual stocks, currencies, precious metals, commodities, and/or the like), generating financial products with different positions with respect to variances, and/or the like. Furthermore, aspects of the FIVI may be configured to generate, administer, and/or manage a wide variety of different financial instruments, securities, and/or the like beyond specific embodiments and/or implementations described in detail herein. For example, indices discussed herein may underly and/or be linked to any of a wide variety of financial products, derivatives, instruments, and/or the like, such as but not limited to: equities, debts, derivatives, notes (e.g., structured notes), stocks, preferred shares, bonds, treasuries, debentures, options, futures, swaps, rights, warrants, commodities, currencies, funds, long and/or short positions, ETFs, insurance and/or risk transfer agreements, annuities, and/or other assets or investment interests. The FIVI may be further adapted to other implementations and/or investment, finance and/or risk management applications.

The invention claimed is:

1. A processor-implemented method for approximating the forward implied variance of an index of underlying financial instruments, the method comprising:
accessing information from at least one database regarding performance information for an underlying index of financial instruments;
establishing, using a controller module, a short position in a one-period variance portfolio at the beginning of a period, the one-period variance portfolio including a plurality of one-period options on the underlying index of financial instruments;
establishing, using a controller module, a long position in a two-period variance portfolio at the beginning of the period, the two-period variance portfolio including a plurality of two-period options on the underlying index;
establishing, using a controller module, a three-period variance portfolio without taking an initial position in the portfolio at the beginning of the period;
rebalancing among the three portfolios at predetermined intervals during the period, such that at the expiration of the period, the long and short positions with respect to a one-period variance portfolio and a two-period variance portfolio are the same as they were on the initial day of the period.

2. The method of claim 1, further comprising establishing a new three-period variance portfolio at the expiration of the period and repeating the rebalancing step.

3. The method of claim 1, wherein the plurality of one-period options includes both one-period put options and one period call options with delta values distributed in the delta value range.

4. The method of claim 3, wherein the delta values are evenly distributed in the delta range.

5. The method of claim 6, wherein, wherein the plurality of two-period options includes both of two-period put options and two period call options with delta values distributed in the delta value range.

6. The method of claim 5, wherein the delta values are evenly distributed in the delta range.

7. The method of claim 6, wherein the delta range is 1% delta to 50% delta.

8. The method of claim 1, wherein the one-period variance portfolio includes an equal number of put options and call options.

9. The method of claim 1, wherein the two-period variance portfolio includes an equal number of put options and call options.

10. A processor-implemented method for transforming information about the performance of a predetermined group of financial instruments into a forward implied variance index, the method comprising:
accessing information from at least one database regarding performance information for an underlying index of financial instruments;
calculating, using a computer, a first one-period forward implied variance for the underlying index at a first time;
calculating, using a computer, a first two-period forward implied variance for the underlying index at the first time;
calculating, using a computer, a second one-period forward implied variance for the underlying index at a second time;
calculating, using a computer, a second two-period forward implied variance for the underlying index at the second time;
calculating, using a computer, a forward implied variance index value at the second time by multiplying a forward implied variance index value at the first time by a weighted sum of the first one-period forward implied variance, the second one-period forward implied variance, the first two-period forward implied variance, and the second two-period forward implied variance; and
outputting the forward implied variance index value at the second time to an output device.

11. The method of claim 10, wherein the period is one month.

12. The method of claim 10, wherein the weighted sum is calculated by determining an individual roll weight for each of the first one-period implied forward variance, the second one-period implied forward variance, the first two-period forward implied variance, and the second two-period forward implied variance, and wherein each of the values for forward implied variance is multiplied by its respective roll weight.

13. The method of claim 12, wherein period is one month, and wherein the individual roll weights are calculated based on a roll period that is a predetermined number of days and wherein the roll period overlaps the one-period and the two period.

14. The method of claim 10, wherein the underlying index of financial instruments is the S&P 500 Index.

15. A processor-implemented method for approximating the forward implied variance of an index of underlying financial instruments, the method comprising:
accessing information from at least one database regarding performance information for an underlying index of financial instruments;
establishing, using a controller module, a forward implied variance portfolio consisting of a short position in a one-period sub-portfolio, a long position in a two-period sub-portfolio, and no position in a three-period sub-portfolio, the forward implied variance being based on the underlying index;
periodically rebalancing the sub-portfolios by purchasing shares in the one-period sub-portfolio, selling shares in the second period sub-portfolio, and purchasing shares in the three-period sub-portfolio, in a quantity such that at expiration of a first period, the two-period portfolio becomes a new one-period portfolio with a short position, and the three-period portfolio becomes a new two-period portfolio with a long position.

16. The method of claim 15, further comprising establishing a new three-period sub-portfolio and repeating the step of periodically rebalancing the sub-portfolios.

17. A processor-implemented method for approximating the forward implied variance of an index of underlying financial instruments, the method comprising:
accessing information from at least one database regarding performance information for an underlying index of financial instruments;
accessing information regarding the forward implied variance of the underlying index over a given period;
automatically creating, using a controller module, three option portfolios based on the forward implied variance of the index with maturities of one period, two periods, and three periods and establishing, at an initial time, a 100% short position in the one-period portfolio, a 200% long position in the two-period portfolio, and no position in the three-period portfolio;
rebalancing the portfolio using the controller module, by, for each of n sub-periods that make up the period, to purchase 1/n shares of the one-period portfolio, to sell 4/n shares of the two-period portfolio, and to purchase 3/n shares of the three-period portfolio such that at the end of one period, the two-period portfolio becomes a new one-period portfolio with a 100% short position, and the three-period portfolio becomes a new two-period portfolio with a 200% long position.

18. The method of claim 17, further comprising the step of automatically creating, using a controller module, a new three-period portfolio at the end of the one period and repeating the rebalancing step.

19. A system for approximating the forward implied variance of an underlying index of financial instruments, the system comprising:
a server having a controller running on a processor and configured to interface with a plurality of databases to access information regarding performance information for an underlying index of financial instruments;
an index calculator module interfacing with the controller and configured to calculate a first one-period forward implied variance and a first two-period forward implied variance for the underlying index at a first time; to calculate a second one-period forward implied variance and a second two-period forward implied variance for the underlying index at a second time; and to calculate a forward implied variance index value at the second time by multiplying a forward implied variance index value at the first time by a weighted sum of the first one-period forward implied variance, the second one-period forward implied variance, the first two-period forward implied variance, and the second two-period forward implied variance;
a market interface module interfacing with the controller and configured to establish a forward implied variance portfolio consisting of a short position in a one-period sub-portfolio, a long position in a two-period sub-portfolio, and no position in a three-period sub-portfolio, the calculated forward implied variance of the underlying index; and
a portfolio manager module interfacing with the controller and configured to periodically rebalance the sub-portfolios by purchasing shares in the one-period sub-portfolio, selling shares in the second period sub-portfolio, and purchasing shares in the three-period sub-portfolio, in a quantity such that at expiration of the one period, the two-period portfolio becomes a new one-period portfolio with a short position, and the three-period portfolio becomes a new two-period portfolio with a long position.

20. The system of claim 19, further comprising a index/product output module interfacing with the controller and configured to output the calculated values of the forward implied variance.
